(19) United States
(12) Patent Application Publication
(10) Pub. No.: US 2011/0005409 A1
(43) Pub. Date: Jan. 13, 2011

(54) HEATED AIR CURTAIN CONTAINER WITH MULTIPLE TEMPERATURE ZONES

(75) Inventor: Michael Majchrzak, Milwaukee, WI (US)

Correspondence Address: FOLEY & LARDNER LLP, 777 EAST WISCONSIN AVENUE, MILWAUKEE, WI, 53202-5306, US

(73) Assignee: Hatco Corporation

(21) Appl. No.: 12/501,245

(22) Filed: Jul. 10, 2009

(51) Int. Cl. A47J 43/00; F24F 9/00

(52) U.S. Cl. 99/468; 99/476; 454/193; 454/192

(57) ABSTRACT

A food container includes an interior chamber sized to contain food items, the interior chamber having a first temperature zone and a second temperature zone. The food container further includes an opening providing access to the interior chamber, a fan configured to supply an air stream to a duct system, and a heater configured to heat the air stream, where the duct system is configured to deliver a portion of the air stream across the opening, creating an air curtain. The food container further includes a diverter disposed in the air curtain to divert a portion of the air stream out of the air curtain and into the interior chamber, the diverter configured to cause the second temperature zone to maintain a second temperature different from the first temperature. The food container further includes a temperature control system having a user interface, an input configured to receive a signal from the user interface, the signal representative of a first temperature, and a processing circuit configured to control the heater to bring the first temperature zone to the first temperature.

### BACKGROUND

The subject matter described herein relates generally to the field of containers. In particular, the subject matter described herein relates to food containers. The food containers may be used for storing food, holding food at a temperature, cooling food, humidifying food, rethermalizing food, warming food, and cooking food.

A wide variety and configuration of food containers are used to house and display food in places such as convenience stores, restaurants, etc. Depending on the type of food, these containers may be heated, cooled, and humidified to prevent the food from becoming cold or hard, thus making the food more appealing to consumers. For example, the containers may be used to house and display donuts, pastries, hot dogs, etc. In other applications, the containers may be used to refrigerate or freeze food to prevent it from melting, spoiling, etc. In still other applications, the containers may be used to hold food at an elevated temperature or to cook food.

Typically, a solid barrier such as a door is used to isolate the interior of the container from the exterior environment. The door prevents the transfer of heat and humidity between the interior of the container and the exterior environment. The door is usually hinged on one side so that it can be opened and closed to provide access to the interior of the container. Continually opening and closing the door may result in a loss of productivity and efficiency on the part of the persons using the containers. Users often desire to quickly remove items from the containers. For example, in a fast food setting, a food preparer may want to be able to quickly access food components (e.g., hot dog buns, hot dogs) to prepare the finished food product (e.g., a hot dog in the bun with desired toppings).

Further, some food containers may contain one type of food product at a specific temperature, but may be unable to store another type of food product that must be maintained at another temperature. For example, in a fast food setting, one type of food product (e.g., a hot dog) may be required to be kept at one temperature while another type of food product (e.g., hot dog buns) may be required to be kept at a different temperature.

### SUMMARY

One embodiment of the invention relates to a heated food container having a first temperature zone and a second temperature zone. The container includes an interior chamber sized to contain food items, the interior chamber having a first temperature zone and a second temperature zone. The container further includes an opening providing access to the interior chamber and a fan configured to supply an air stream to a duct system. The container further includes a heater configured to heat the air stream, where the duct system is configured to deliver a portion of the air stream across the opening, creating an air curtain. The container further includes a diverter disposed in the air curtain to divert a portion of the air stream out of the air curtain and into the interior chamber, the diverter configured to cause the second temperature zone to maintain a second temperature different from the first temperature. The container further includes a temperature control system having a user interface, an input configured to receive a signal from the user interface, the signal representative of a first temperature, and a processing circuit configured to control the heater to bring the first temperature zone to the first temperature.

Another embodiment of the invention relates to a heated food container an interior chamber sized to contain food items, an opening providing access to the interior chamber, and a fan configured to supply air to a duct system. The container further includes a heater configured to heat the air, where the duct system is configured to deliver a portion of the air across the opening, creating an air curtain. The container further includes a sensor located in the interior chamber, the sensor configured to sense the temperature of the interior chamber at the location of the sensor, and a diverter disposed in the air curtain to divert a portion of the air out of the air curtain and into the interior chamber.

Another embodiment of the invention relates to a food container having a user interface for receiving a first temperature from a user, a first temperature zone, and at least one heating elements. The food container further includes a processing circuit configured to receive a signal representative of the first temperature from the user, where the processing circuit is further configured to control the heating element to maintain the first temperature zone at the first temperature, where the cabinet is configured to maintain the second temperature zone at a temperature at least thirty degrees Fahrenheit cooler than the first temperature. The food container does not include a mechanism for allowing a user to select the second temperature directly.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a top perspective view of a container, according to an exemplary embodiment.

FIG. 2 is a front elevation view of the container of FIG. 1, according to an exemplary embodiment.

FIG. 3 is a side elevation view of the container of FIG. 1, according to an exemplary embodiment.

FIG. 4 is a sectional view of the container of FIG. 2 along line 4-4, according to an exemplary embodiment.

FIG. 5 is a sectional view of the container of FIG. 3 along line 5-5, according to an exemplary embodiment.

FIG. 6 is a top perspective view of the container of FIG. 1 with the outside covers removed, according to an exemplary embodiment.

FIG. 7 is a top perspective view of the top portion of the container of FIG. 6 with additional covers removed, according to an exemplary embodiment.

FIG. 8 is a sectional view of a container having two air curtains, according to an exemplary embodiment.

FIG. 9 is a block diagram of a temperature control system, according to an exemplary embodiment.

FIG. 10 is a front elevation view of a container, according to another exemplary embodiment.

FIG. 11 is a sectional view of the container of FIG. 10 along line 11-11, according to an exemplary embodiment.

### DETAILED DESCRIPTION OF THE EXEMPLARY EMBODIMENTS

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

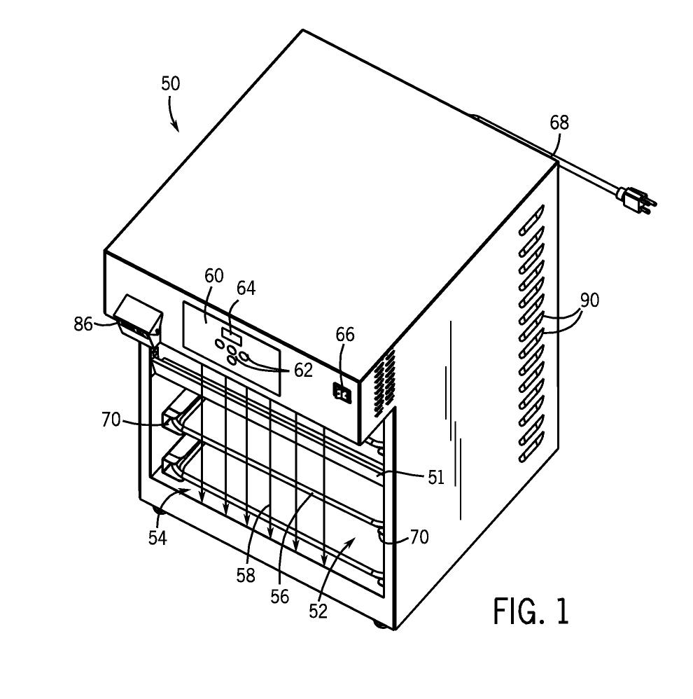

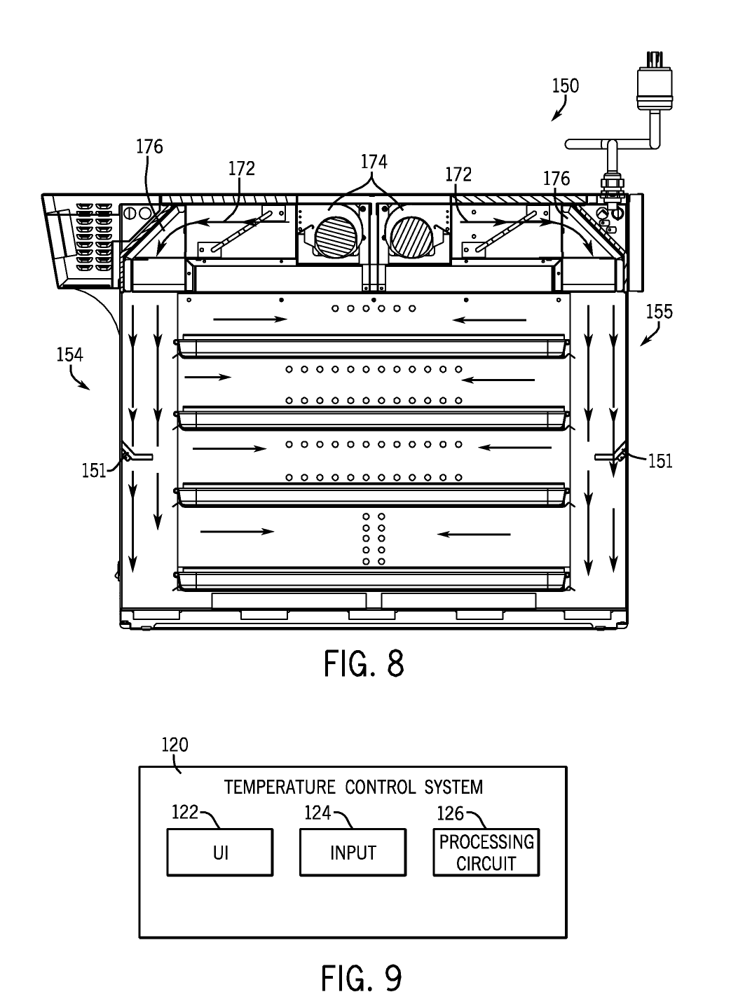

FIGS. 1, 2, and 3 show a top perspective, front perspective, and side elevation view, respectively, of a container 50 (e.g., a food container) according to one embodiment. Container 50 includes an interior chamber 52, which is configured to house items such as food in a controlled environment. Container 50 as shown in FIGS. 1-7 is shaped similarly to a box with an opening 54 on one side of container 50 for moving food between interior chamber 52 and the exterior of container 50. In other embodiments, container 50 may be any of a number of suitable shapes and configurations. For example, container 50 may be substantially cylindrical, etc. Also, container 50 may be configured to be portable (e.g., moved by hand, rolled on castors, etc.) or fixed in a stationary position using a suitable fastening mechanism (e.g., welding, bolted, glued, etc.). In another embodiment, opening 54 may be located on a top side of container 50. In still another embodiment, container 50 may include two, three, or more openings 54 for moving food between the interior and the exterior of container 50. For example, in the embodiment of FIG. 8, container 50 is shown with two openings 54, 55 on either side of container 50. In yet another embodiment, container 50 may comprise transparent sides (e.g., glass, plastic, etc.) so that the food is visible.

In one embodiment, container 50 includes a control system, which is used to maintain the physical characteristics (e.g., temperature, humidity, etc.) of the air in chamber 52 substantially constant. The control system is typically configured to control both temperature and humidity of the air in chamber 52. However, in other embodiments, the control system may be configured to control only one of the temperature and humidity of the air in chamber 52 or may be configured to control additional properties of the air in chamber 52 such as the air flow rate. In general, the control system includes the components that are used to control the temperature and humidity of the air in container 50. In one embodiment, the control system includes at least a thermometer and a hygrometer. In another embodiment, the control system includes a thermostat and a humidistat which are used to control the temperature and humidity, respectively, of the air in chamber 52. In still another embodiment, the control system may include infinite controls for controlling the temperature and humidity of the air in chamber 52.

Container 50 is shown to include a control panel 60. Control panel 60 may be used to provide an input (e.g., an input for setting a temperature or humidity level, etc.) to the control system. In one embodiment, as shown in FIGS. 1-3, control panel 60 includes buttons 62 and display 64 (e.g., a temperature display). Buttons 62 may be used to input a desired temperature or humidity level. Display 64 is configured to show the user the current set point or the actual temperature and humidity levels. In addition, container 50 also includes a power switch 66 and a power cord 68. In other embodiments, control panel 60 may include other input devices and displays. For example, control panel 60 may include rotary dials instead of or in addition to buttons 62. Also, control panel 60 may be distributed on container 50. For example, display 64 may be located on one side of container 50 and buttons 62 may be located on another side of container 50. In yet another embodiment, container 50 may be supplied with a computer interface for interfacing with a computerized control system or a computerized information source. In yet another embodiment, control panel 60 may be located in any position on container 50 or otherwise connected to the control system of container 50.

As mentioned previously, container 50 defines at least one opening 54 through which food may be moved between the interior and the exterior of container 50. Opening 54 may be any suitable size and shape. In the embodiment shown in FIGS. 1-3, opening 54 is quadrilateral and substantially planar. Opening 54 may be positioned in a substantially vertical plane, as shown in FIGS. 1-3, or may be positioned in a number of other planes (e.g., a substantially horizontal plane for a container where opening 54 is on a top side or a plane at any degree of inclination between a horizontal plane and a vertical plane).

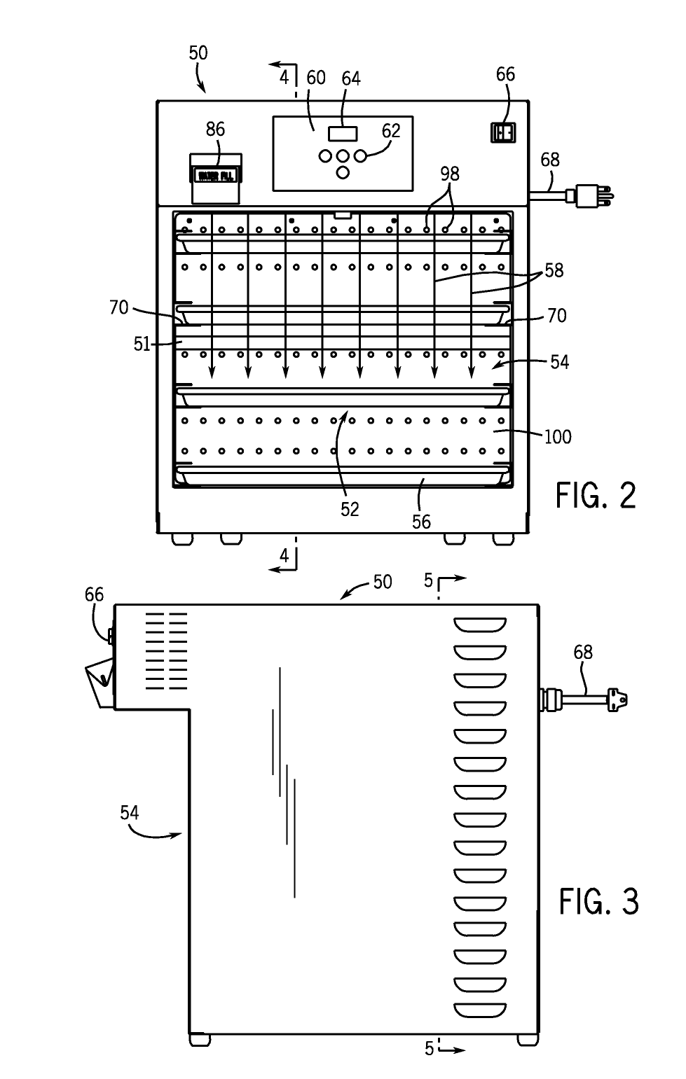

In the embodiment shown in FIGS. 1 and 2, trays 56 are used to support food (e.g., pastries, brownies, hot dogs, etc.). Trays 56 are of a sufficient size to pass through opening 54 and be received by rails 70 (or any other object used for supporting trays 56) in chamber 52. In other embodiments, food may be moved between the interior and the exterior of container 50 in a variety of other suitable ways (e.g., individual food items placed in container 50 without using trays 56, other containers such as pans may be used to store the food items, etc.).

Container 50 uses an air curtain 58 to form a barrier between interior chamber 52 of container 50 and the exterior environment. A user can easily reach through, or otherwise pierce, air curtain 58 to move food between chamber 52 and the exterior of container 50. Thus, air curtain 58 provides an effective barrier between chamber 52 and the exterior environment yet eliminates the need for the user to open a door while moving food into and out of container 50. Air curtain 58 may also provide an effective barrier against insects and other foreign matter that may otherwise enter chamber 52. Additionally, a portion of the air from air curtain 58 may be used to humidify, cool, or heat the interior of container 50.

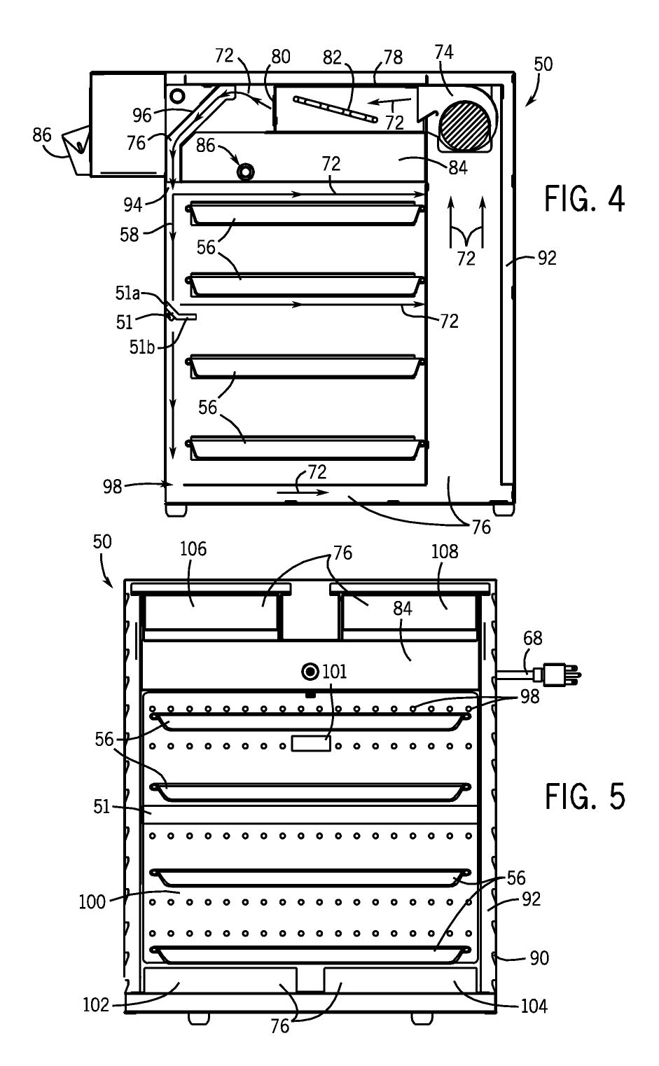

Referring to FIG. 4, in an exemplary embodiment, container 50 includes a diverter shown as an air zone baffle 51. Air zone baffle 51 is configured to adjust the air flow created by air curtain 58 such that one zone (e.g., the interior of container 50 above baffle 51) may be kept at a higher temperature relative to another zone (e.g., the interior of container 50 below baffle 51). Baffle 51 is used to adjust the air flow created by air curtain 58 by diverting a portion of the air stream making up air curtain 58, sending the diverted portion of the air stream into interior chamber 52 of container 50, while leaving the remaining portion of the air stream to form air curtain 58 for the lower zone. The air stream diversion causes the temperature for an upper temperature zone of container 50 to differ (e.g., be warmer) from that of a lower temperature zone, creating two temperature zones within interior chamber 52. For example, the diversion of the some of the air stream using baffle 51 may allow more warm air to circulate in the upper temperature zone of container 50 as compared to the lower temperature zone of container 50, resulting in the upper temperature zone of container 50 having a higher temperature relative to the lower portion.

According to various exemplary embodiments, the position and structure of baffle 51 may be altered to create various zones (e.g., a different sized upper zone and lower zone, three or more zones, etc.) for container 50. In the embodiment shown in FIGS. 1, 2, and 4, baffle 51 is shown placed in the middle of the opening 54, roughly evenly dividing container 50 into two temperature zones. In another embodiment, the location of baffle 51 may be adjusted away from the center of the opening 54 to change the relative sizes of the upper and lower zones.

Referring to FIG. 4, baffle 51 may be made of two substantially planar plates coupled together at an angle to form a “V” shape. Baffle 51 may have various dimensions. According to one embodiment, baffle 51 may include one plate 51a with a width of ½″ and another plate 51b with a width of ⅜″, with the two pieces offset at an angle. According to various other embodiments, either plate 51a, 51b of baffle 51 may be of a different width, and plates 51a, 51b may be offset at various angles (e.g., 30 degrees, 60 degrees, etc.). The dimensions of plates 51a, 51b may be adjusted such than a change in the configuration of baffle 51 may result in a change in temperature of the two or more temperature zones of container 50. For example, the angle of baffle 51 relative to air curtain 58 may be changed such that more or less air is diverted into the upper temperature zone (e.g., a widened angle may allow baffle 51 to “catch” more of the air flow and to divert more air to the upper temperature zone, increasing the difference in temperature between the two zones). As another example, the width of either plate 51a, 51b may be shortened or widened to allow for more or less air to be diverted into the upper temperature zone (e.g., a shortening of plate 51b may allow more air to reach the lower temperature zone, resulting in a reduced difference in temperature between two zones).

The difference in temperature between the two temperature zones may be changed by adjusting the dimensions of baffle 51. According to one exemplary embodiment, a ratio of temperatures between the two temperature zones may be adjusted by altering baffle 51. For example, container 50 and baffle 51 may be configured such that a lower temperature zone should be in the range of 60%-80% of the upper temperature zone, and an adjustment of baffle 51 may increase or decrease the range (e.g., increase the range to be 70%-90%, decrease the range to be 50%-70%, etc.). As another example, container 50 may be configured such that a lower temperature zone should be approximately 40 degrees Fahrenheit less than an upper temperature zone, and an adjustment of baffle 51 may increase or decrease the difference (e.g., decrease the difference to approximately 20 degrees Fahrenheit or increase the difference to approximately 60 degrees Fahrenheit, etc.). For instance, the upper temperature zone may maintain a temperature range of 190-200 degrees Fahrenheit, while the lower temperature zone maintains a temperature range of 140-150 degrees Fahrenheit.

Still referring to FIG. 4, container 50 includes at least one fan 74 and a duct system 76 which are configured to circulate air stream 72 through container 50. In general, fans 74 are electrically operated and configured to provide a constant air flow rate. In another embodiment, fans 74 may be adjustable to provide varying controlled (actively or passively) air flow rates. Fans 74 are provided with outside ventilation using louvers 90 (shown in FIG. 5), which allow air to enter a ventilation space 92. Ambient air that enters louvers 90 is kept separate from air stream 72. In another embodiment, air stream 72 may comprise ambient air that is continually being combined with circulated air. In another embodiment, air stream 72 may include only ambient air that is brought in through a vent then expelled back into the ambient environment after it has been used to create air curtain 58.

In FIG. 4, the general flow of an air stream 72 is shown. As shown in FIGS. 4, 6, and 7, fans 74 blow air into a baffle box 78. Baffle box 78 is a substantially enclosed box including a baffle 80 through which air stream 72 is forced to pass. Before passing through baffle 80, air stream 72 may be heated using heating element 82 (e.g., a heater). In other embodiments, heating element 82 may be located in any suitable position in duct system 76. After being heated, air stream 72 passes through baffle 80. In the embodiment shown in FIGS. 4, 6, and 7, baffle 80 may be a perforated, substantially planar, plate. Typically, the perforations in baffle 80 are also substantially uniform. As air stream 72 passes through the perforations in baffle 80, the velocity of air stream 72 increases briefly before slowing down on the other side of baffle 80. Also, baffle 80 provides a pressure drop.

After passing through baffle 80, air stream 72 passes over water source 84 to humidify air stream 72. Once air stream 72 exits baffle 80 the velocity of air stream 72 decreases substantially. The decrease in velocity of air stream 72 and/or the pressure drop across baffle 80 allows air stream 72 to pick up water from water source 84 better than if baffle 80 was not present. Water source 84 includes a heating element 82 which can be used to heat the water and provide a controlled amount of water vapor to be picked up by air stream 72. Water source 84 is filled using water input 86. Water placed in water input 86 passes through water tube 88 to water source 84. In another embodiment, water source 84 may be coupled to a continuous water supply that refills water source 84 when it gets low (e.g., a float with a valve that turns on when the water level of water source 84 is low). In other embodiments, container 50 may be configured without a water source 84 or any system for humidifying air stream 72. Alternatively, the container may have a control system that permits sale of the engagement or disengagement of the humidification function. This may be desirable in connection with foods that do not need to be humidified.

Referring to FIGS. 4 and 5, after passing over water source 84, air stream 72 travels through duct 96, which is a part of duct system 76. As air stream 72 enters duct 96, the velocity of air stream 72 increases due to the smaller area through which air stream 72 now passes. Air stream 72 exits duct 96 through nozzles 94, which are positioned adjacent opening 54 in a downward direction. As air stream 72 passes downward over opening 54, air curtain 58 is created. Air from air curtain 58 returns back to fans 74 through a plurality of air returns 98 in duct system 76. At least one of air returns 98 is positioned adjacent to opening 54 opposite nozzles 94. Air returns 98 positioned opposite nozzles 94 receive a portion of air stream 72 that exits nozzles 94. At least one of air returns 98 is positioned on a first side 100 of chamber 52. Generally, first side 100 is positioned opposite opening 54. Food placed in trays 56 is positioned substantially between air returns 98 positioned on first side 100 and opening 54. A portion of air stream 72 passes over and/or around the food before entering air returns 98 positioned on first side 100. Thus, the water content of the food and the temperature and/or humidity of the air in chamber 52 may be controlled using air from air stream 72. In one embodiment, the air from air stream 72 is used to maintain the desired temperature and humidity of chamber 52 without the use of additional temperature and humidity control systems.

As shown in FIGS. 2 and 5, first side 100 is perforated according to a substantially uniform pattern to provide a plurality of distributed air returns 98. In one embodiment, the size of the perforations is between approximately 3 millimeters and approximately 10 millimeters or, desirably, between approximately 5 millimeters and approximately 8 millimeters. In still another embodiment, first side 100 is configured to include a higher density of air returns 98 near trays 56. This allows the portion of air stream 72 that passes through the air returns on first side 100 to be nearer to the food, thus enhancing the heat transfer and/or humidification of the food. In other embodiments, first side 100 may comprise a single air return 98 located in any suitable position. After air stream 72 passes through air returns 98, air stream 72 travels through duct system 76 back to fans 74 to begin the cycle again.

Referring to FIG. 5, duct system 76 includes two separate ducts 102 and 104 through which air is returned from chamber 52 to fans 74. Also, each fan 74 has separate outlet ducts 106 and 108. In other embodiments, duct system 76 may include a single duct to circulate air stream 72 through container 50. In still other embodiments, duct system 76 may include a filter to capture any particles that may dislodge from the food as it is passed through air curtain 58.

Still referring to FIG. 5, a sensor 101 is shown in the upper zone of interior chamber 52 of container 50. Sensor 101 is configured to sense a current temperature or humidity level of the upper zone of interior chamber 52 of container 50 and to provide the temperature or humidity level reading to display 64 of control panel 60 or otherwise. Sensor 101 may be placed in the upper zone of container 50 such that the only temperature or humidity level reading displayed on display 64 is of the upper zone. According to various exemplary embodiments, sensor 101 may be placed elsewhere within container 50 to sense a temperature or humidity level of another area (e.g., the lower temperature zone), or multiple sensors 101 may be placed within container 50.

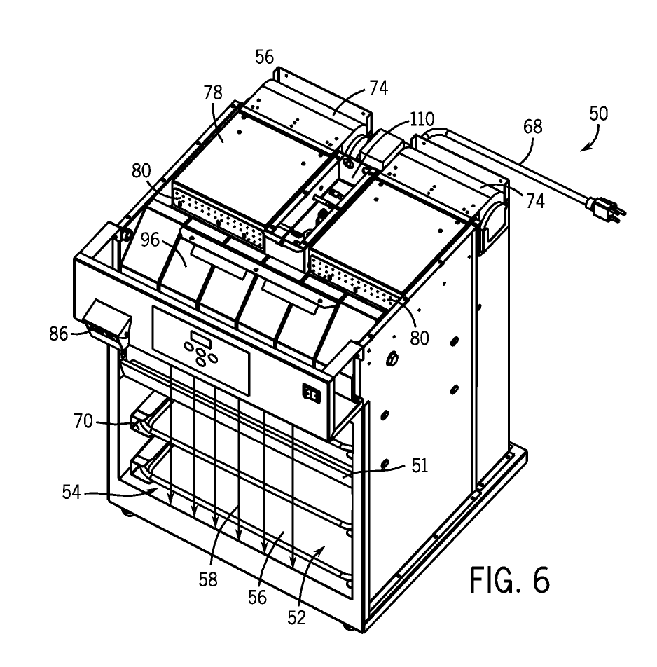

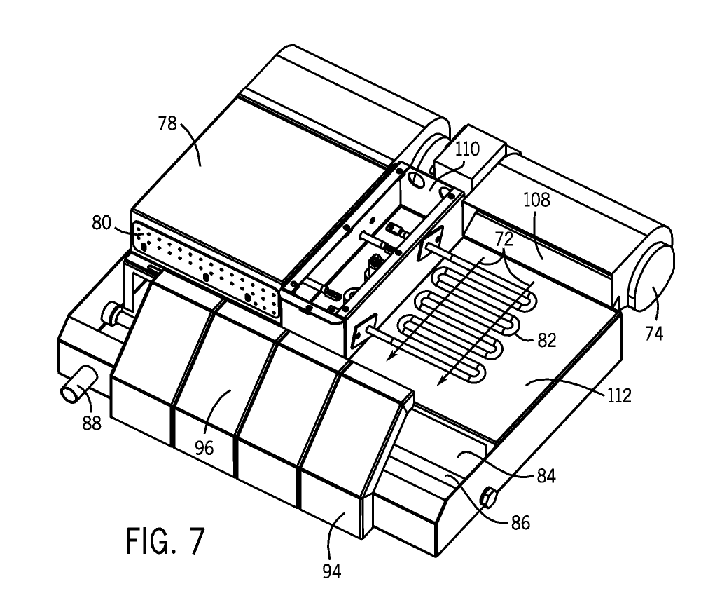

Referring to FIGS. 6 and 7, a top perspective view of container 50 with the outside covers removed is shown. FIGS. 6 and 7 provide a top perspective view of fans 74, baffle box 78, baffles 80, ducts 96, and wiring enclosure 110. Wiring enclosure 110 houses electrical wires that provide power to heating elements 82 as well as other electrical devices. Referring specifically to FIG. 7, underneath baffle boxes 78 are covers 112, which cover water source 84. Covers 112 help to isolate water source 84 from heating elements 82. Air stream 72 exits fan outlet ducts 106 and 108, travels through baffle boxes 78 and into ducts 96.

According to various embodiments, the components of container 50 may be configured in various ways. For example, in one embodiment, fan 74, baffle 80, and water source 84 may be located at the bottom of container 50. Fan 74 may then be configured to circulate air through container 50 in a manner similar to the previous embodiments; however, the air in air curtain 58 would flow upward from nozzles 94 to air returns 98. In another embodiment, a top side of a container 50 may include opening 54. Accordingly, air curtain 58 may be substantially horizontal and may provide a barrier between chamber 52 and the exterior environment. The majority of the air from air curtain 58 is received by one or more air returns 98 positioned adjacent to opening 54 and opposite nozzles 94 while the remainder is received by air returns 98 positioned in a bottom side of container 50. This embodiment may also include any other features described or discussed in relation to other previous embodiments.

Referring to FIG. 8, a container 150 is shown according to another embodiment. Compared to the embodiment of FIG. 4, container 150 in FIG. 8 is shown with two openings 154, 155. Container 150 is shown with two fans 174 and two duct systems 176, each configured to circulate an air stream 172 through a respective side of container 150. Each side of container 150 further includes a diverter, shown as baffle 151 and similar components. A user of container 150 may then move food items in and out of container 150 from either side. According to various exemplary embodiments, baffle 151 on either side of container 150 may be symmetrical or located or adjusted differently to provide various internal temperature zones as desired. Container 150 may otherwise generally have the same components and functionality as shown in container 50 of FIGS. 1-7.

Referring to FIG. 9, a block diagram of a temperature control system 120 (e.g., a control system coupled to control panel 60) is shown in greater detail, according to an exemplary embodiment. Temperature control system 120 includes a user interface (UI) 122, an input 124, and a processing circuit 126. UI 122 may be configured to accept a user input regarding a temperature or humidity setting. For example, UI 122 may consist of control panel 60 and/or any other user input panel (i.e., UI 122 includes one or more buttons for increasing or decreasing a temperature setting, and a display for displaying a current or set temperature). Input 124 may be configured to receive a signal from UI 122 (e.g., a signal relating to the pressing of a button or rotating of a dial or knob in control panel 60). Processing circuit 126 is configured to receive a signal from input 124 and to adjust an air flow or other property of container 50 such that a change in temperature and/or humidity of one or more temperature zones of container 50 is made (e.g., adjusting a temperature of an upper temperature zone based on the received signal from the input). Temperature control system 120 may additionally be coupled to sensor 101 (for using and displaying a current sensor reading of temperature or humidity using display 64 of control panel 60), any other electronics of container 50 (e.g., power switch 66), or any other component of container 50.

According to an exemplary embodiment, processing circuit 126 of temperature control system 120 and control panel 60 may accept an input for setting a temperature for the upper temperature zone of container 50. Processing circuit 126 may only accept an input for the upper temperature zone (i.e., processing circuit 126 may not accept an input for the lower temperature zone). Additionally, UI 122 may display a temperature of the upper temperature zone but not display a temperature of the lower temperature zone. In other words, control panel 60 and temperature control system 120 may provide a user of container 50 a way to adjust and view the current temperature of the upper temperature zone of container 50 without providing the user with a direct way to adjust the lower temperature zone. In such an embodiment, the temperature of the lower temperature zone is a function of the temperature of the upper temperature zone and the size, configuration, and position of baffle 51. In another embodiment, temperature control system 120 and control panel 60 may be configured to display a temperature of the lower temperature zone (whether measured by another sensor or calculated based upon some function of the temperature of the upper temperature zone).

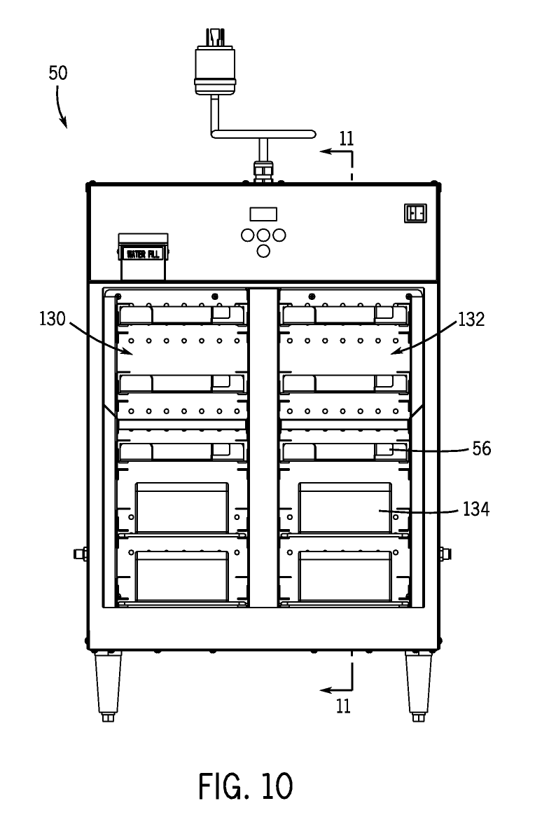

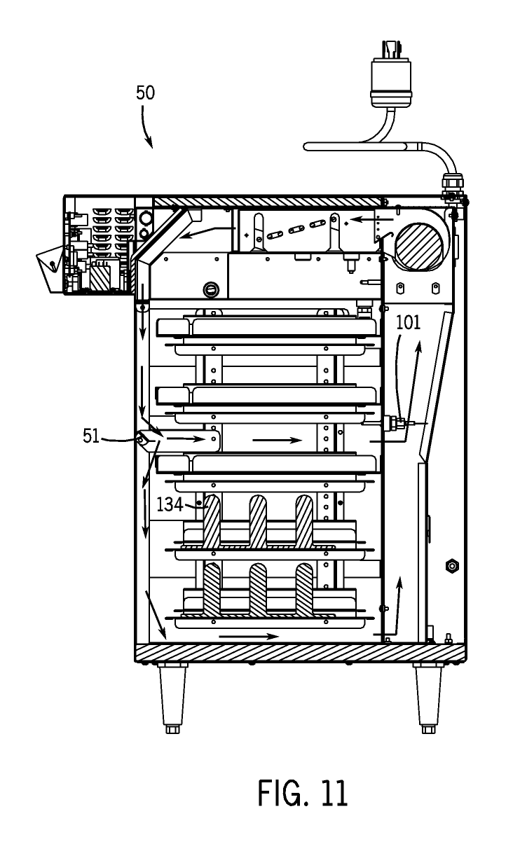

According to various embodiments, container 50 may have a diverter that includes more than one baffle 51. Such a configuration may allow for more than two temperature zones for container 50. Additionally, for example, in the embodiments shown in FIGS. 10 and 11, container 50 is further divided into a left portion 130 and a right portion 132, with food storage capabilities on either side. Container 50 may use any storage method for storing items; for example, in addition to trays 56, a platform or support member 134 may hold food items. Container 50 is shown with two baffles 51 which divide container 50 into four temperature zones (two upper temperature zones and two lower temperature zones). According to one exemplary embodiment, the two upper temperature zones may be the same temperature, in other embodiments, container 50 may be configured to maintain the two upper temperature zones at different temperatures (and the lower temperature zones at different temperatures as a result).

Referring further to FIG. 11, sensor 101 is shown mounted to the back wall of container 50. Sensor 101 is shown placed in an upper temperature zone of container 50 such that sensor 101 may provide control panel 60 with a current temperature measurement from sensor 101. According to other embodiments, sensor 101 may be located elsewhere (e.g., in another temperature zone) in container 50 and/or more than one sensor 101 may be located in container 50.

The construction and arrangement of the elements described herein are illustrative only. Although only a few embodiments have been described in detail in this disclosure, those who review this disclosure will readily appreciate that many modifications are possible without materially departing from the novel teachings and advantages of the subject matter recited in the claims. Accordingly, all such modifications are intended to be included within the scope of the methods and systems described herein. The order or sequence of any process or method steps may be varied or re-sequenced according to alternative embodiments. Other substitutions, modifications, changes and omissions may be made in the design, operating conditions and arrangement of the embodiments without departing from the spirit and scope of the methods and systems described herein.

What is claimed is:

1. A heated food container having a first temperature zone and a second temperature zone, comprising:
an interior chamber sized to contain food items, the interior chamber having a first temperature zone and a second temperature zone;
an opening providing access to the interior chamber;
a fan configured to supply an air stream to a duct system;
a heater configured to heat the air stream;
wherein the duct system is configured to deliver a portion of the air stream across the opening, creating an air curtain;
a diverter disposed in the air curtain to divert a portion of the air stream out of the 11 air curtain and into the interior chamber, the diverter configured to cause the second temperature zone to maintain a second temperature different from the first temperature; and
a temperature control system comprising:
a user interface;
an input configured to receive a signal from the user interface, the signal representative of a first temperature; and
a processing circuit configured to control the heater to bring the first temperature zone to the first temperature.

2. The container according to claim 1, wherein the opening comprises a top and a bottom and the diverter is located approximately halfway between the top and the bottom.

3. The container according to claim 1, wherein the diverter is a baffle.

4. The container according to claim 1, wherein the second temperature differs from the first temperature by at least 30 degrees Fahrenheit.

5. The container according to claim 1, wherein the second temperature is in the range of 60-80% of the first temperature.

6. The container according to claim 1, wherein the processing circuit uses the signal representative of the first temperature as the only user input of temperature.

7. The container according to claim 1, wherein the user interface comprises a temperature display and at least one button for increasing or decreasing the temperature shown on the display, and wherein the temperature shown on the display is the first temperature.

8. The container according to claim 7, wherein the food container does not include an additional temperature display or user interface for receiving temperature input from a user.

9. The container according to claim 1, wherein the control system does not include a user interface for allowing direct user adjustment of the second temperature.

10. A heated food container, comprising:
an interior chamber sized to contain food items;
an opening providing access to the interior chamber;
a fan configured to supply air to a duct system;
a heater configured to heat the air;
wherein the duct system is configured to deliver a portion of the air across the opening, creating an air curtain;
a sensor located in the interior chamber and configured to sense the temperature of the interior chamber at the location of the sensor; and
a diverter disposed in the air curtain to divert a portion of the air out of the air curtain and into the interior chamber.

11. The container according to claim 10, wherein the interior chamber comprises an first temperature zone and a second temperature zone and wherein the sensor is located in the first temperature zone.

12. The container according to claim 10, further comprising:
a second opening into the interior chamber, the duct system configured to deliver a second portion of the air across the second opening to create a second air curtain;
a second diverter disposed in the second air curtain to divert a portion of the air crossing the second opening out of the second air curtain and into the interior chamber.

13. The container according to claim 10, wherein the opening comprises a top and a bottom and the diverter is located approximately halfway between the top and the bottom.

14. The container according to claim 10, wherein the diverter comprises one or more baffles.

15. The container according to claim 14, wherein the angle of the baffle relative to the air curtain is adjustable.

16. The container according to claim 14, wherein the location of the baffle is adjustable.

17. A food container comprising:
a user interface for receiving a first temperature from a user;
a first temperature zone and a second temperature zone;
at least one heating element; and
a processing circuit configured to receive a signal representative of the first temperature from the user;
wherein the processing circuit is further configured to control the at least one heating element to maintain the first temperature zone at the first temperature;
wherein the container is configured to maintain the second temperature zone at a temperature at least thirty degrees Fahrenheit cooler than the first temperature;
wherein the container does not include a mechanism for allowing a user to select the second temperature directly.

18. The container according to claim 17, wherein the container further comprises:
a sensor for determining the temperature of the second temperature zone; and
a display for displaying the temperature of the second temperature zone.

19. The container according to claim 18, wherein the container does not include a control loop for maintaining the second temperature in the second temperature zone.

20. The container according to claim 17, further comprising a sensor located in the first temperature zone and configured to sense the temperature at the location of the sensor.
